(19) United States
(12) Patent Application Publication
(10) Pub. No.: US 2023/0294538 A1
(43) Pub. Date: Sep. 21, 2023

(54) AUTOMATIC CHARGING DEVICE FOR CONDUCTIVELY CHARGING BATTERY-ELECTRIC VEHICLES

(71) Applicant: PHOENIX CONTACT E-Mobility GmbH, Schieder-Schwalenberg (DE)

(72) Inventors: Carsten Kuckuck, Hameln (DE); Markus Kroner, Schieder-Schwalenberg (DE)

(21) Appl. No.: 18/009,001

(22) PCT Filed: Jun. 9, 2021
(86) PCT No.: PCT/EP2021/065416

§ 371 Date: Dec. 8, 2022

(30) Foreign Application Priority Data
Jun. 10, 2020 (BE) BE2020/5417

(51) Int. Cl. B60L 53/37; H01R 13/66; H01R 13/631; B60L 53/16; B60L 53/66

(52) U.S. Cl. CPC B60L 53/37; B60L 53/16; B60L 53/66; H01R 13/631; H01R 13/6691

(57) ABSTRACT

An arrangement for establishing a plug-in connection between an energy charging station and a vehicle in order to transmit energy into an energy storage device of the vehicle includes: a first plug-in device which is connectable or connected to the energy charging station; and a second plug-in device which is connectable or connected to the vehicle, the second plug-in device having at least one signal transmitting unit. The first plug-in device has at least one signal receiving unit for receiving at least one signal of the at least one signal transmitting unit. The at least one signal receiving unit and the at least one signal transmitting unit are arranged on the first and the second plug-in device and arranged with respect to one another such that the at least one received signal is provided for orienting and/or positioning the first plug-in device with respect to the second plug-in device.

### CROSS-REFERENCE TO PRIOR APPLICATIONS

This application is a U.S. National Phase application under 35 U.S.C. § 371 of International Application No. PCT/EP2021/065416, filed on Jun. 9, 2021, and claims benefit to Belgian Patent Application No. BE 2020/5417, filed on Jun. 10, 2020. The International Application was published in German on Dec. 16, 2021 as WO/2021/250072 under PCT Article 21(2).

### FIELD

The invention relates to an arrangement for establishing a plug-in connection, preferably automatically, between an energy charging station and a vehicle in order to transmit energy, preferably electrical energy, into an energy storage device of the vehicle. The invention further relates to a method for establishing a plug-in connection between an energy charging station and a vehicle in order to transmit energy, preferably electrical energy, into an energy storage device of the vehicle.

### BACKGROUND

Arrangements, systems, and methods by means of which battery-electric vehicles can be conductively charged automatically are known from the prior art. Conductive charging is a charging technology for electric vehicles, i.e., electrically operated vehicles, for example battery-electric passenger cars or utility vehicles (trucks, buses etc.), in which the energy transmission takes place by means of a cable and/or a contact.

The charging interface between a charging station and a vehicle often forms a unit consisting of a charging plug and a charging socket, wherein the charging plug can be plugged into the charging socket in order to transmit the energy, preferably electrical energy, into the energy storage device of the vehicle (for example accumulator, supercapacitor etc.).

Combined charging methods are often used in which the unit consisting of charging plug and charging socket can transmit small and large amounts of power (alternating current and direct current charging methods). In addition, said charging methods are at least partially automatic with respect to establishing the plug-in connection between charging plug and charging socket, i.e., the charging plug and the charging socket are brought together automatically via robot arms, cameras, sensors, signal generators etc.

For example, DE 10 2018 006 749 A1 describes a first plug connector unit having a camera and a second plug connector unit having a feature, for example a light-emitting diode, to be detected by the camera. The camera is connected pivotably to an energy charging station by means of a robot arm, whereas the second plug connector unit is arranged with its charging socket on an outside of a passenger vehicle. The determination of the position of the second plug connector unit takes place by means of a triangulation method, wherein the plug connector unit has three light-emitting diodes for this purpose.

From DE 10 2017 121 854 A1, a charging socket is known having three integrated optical transmitters whose position is detected with a camera in order to then orient the charging plug in accordance with the position of the charging socket.

DE 10 2015 215 127 A1 describes a detection of light signals by a camera and, on the basis thereof, an automated positioning of a motor vehicle when approaching a target.

### SUMMARY

In an embodiment, the present invention provides an arrangement for establishing a plug-in connection between an energy charging station and a vehicle in order to transmit energy into an energy storage device of the vehicle, comprising: a first plug-in device which is connectable or connected to the energy charging station; and a second plug-in device which is connectable or connected to the vehicle, the second plug-in device comprising at least one signal transmitting unit, wherein the first plug-in device comprises at least one signal receiving unit configured to receive at least one signal of the at least one signal transmitting unit, wherein the at least one signal receiving unit and the at least one signal transmitting unit are arranged on the first and the second plug-in device and configured with respect to one another such that the at least one received signal is provided for orienting and/or positioning the first plug-in device with respect to the second plug-in device, and wherein, at least for establishing the plug-in connection between the first and the second plug-in device, a line-of-sight connection and/or a signal connection is formed between the at least one signal receiving unit and the at least one signal transmitting unit.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a perspective view of an exemplary embodiment of the first plug-in device;

FIG. 2 a perspective view of an exemplary embodiment of the second plug-in device, together with a schematically illustrated signal receiving unit of the first plug-in device;

FIG. 3A a front view of the second plug-in device shown in FIG. 2;

FIG. 3B a side view of the second plug-in device shown in FIG. 2;

FIG. 4 an enlarged view of a partial region of the second plug-in device shown in FIG. 2;

FIG. 5 an exemplary embodiment of a signal transmitting unit with two light sources;

FIG. 6 a further exemplary embodiment of a signal transmitting unit with a light source and a diaphragm;

FIG. 7 an exemplary embodiment of the arrangement according to the invention.

### DETAILED DESCRIPTION

In an embodiment, the present invention provides an improved arrangement for the automated conductive charging of vehicles, preferably battery-powered (battery-electric) vehicles. Further, it is an additional object of the invention to provide an improved method for the automatic conductive charging of such vehicles.

According to a first general aspect, the invention relates to an arrangement or a system for establishing, preferably automatically establishing, a plug-in connection, preferably a releasable and/or positive-fit plug-in connection, between at least one energy charging station and at least one vehicle in order to transmit energy, preferably electrical energy, into an energy storage device of the vehicle. The arrangement or the system comprises a first plug-in device, preferably a translational and/or rotational and/or pivotable plug-in device, which can be connected or is connected to the at least one energy charging station, preferably a power charging station. The arrangement or the system comprises a second plug-in device which can be connected or is connected to the at least one vehicle, wherein the second plug-in device comprises at least one signal transmitting unit, and the first plug-in device comprises at least one signal receiving unit for receiving at least one (transmitted) signal of the at least one signal transmitting unit.

The arrangement or the system is characterized in that the at least one signal receiving unit and the at least one signal transmitting unit are arranged on the first and on the second plug-in device and are configured with respect to one another, preferably configured so as to be able to communicate with one another, in such a way that the at least one received signal is provided for orienting and/or positioning the first plug-in device with respect to the second plug-in device; and in that, at least for the establishing, preferably during the establishing, of the plug-in connection between the first and the second plug-in device, a preferably interruption-free or obstacle-free line-of-sight connection and/or a preferably interruption-free or obstacle-free signal connection is formed between the at least one signal receiving unit and the at least one signal transmitting unit, preferably at least until the establishing of the plug-in connection is completed and/or beyond, for example at least until the process for transmitting energy into the energy storage device of the vehicle is complete.

The first plug-in device can, for example, be designed as a charging plug or, for example, comprise a charging plug. The second plug-in device can, for example, be designed as a charging socket into which a charging plug can be plugged or, for example, can comprise a charging socket.

The at least one signal receiving unit can, for example, be designed as a camera or, for example, comprise a camera, which camera is preferably arranged on a plug side, that is to say a side of the first plug-in device which is designed to establish the plug-in connection.

The at least one signal transmitting unit can, for example, be a transmitter of electromagnetic radiation, i.e., of at least one electromagnetic radiation signal, or, for example, comprise a transmitter of electromagnetic radiation, which transmitter is preferably arranged on the plug side, that is to say a side of the second plug-in device which is designed to establish the plug-in connection.

The at least one signal can comprise, for example, a position signal and/or a direction signal and/or a distance signal which represents the (spatial) position and/or the (spatial) orientation and/or the (spatial) distance of the second plug-in device with respect to the first plug-in device.

The arrangement and/or the configuration of the at least one signal transmitting unit and the at least one signal receiving unit with respect to one another that, at least during the establishing of the plug-in connection, they are in a continuous, i.e., uninterrupted, line-of-sight connection and/or signal connection, enables, for example, an even more precise process for establishing the plug-in connection. In other words, the establishing of the plug-in connection, i.e., the pushing together of the first and the second plug-in device or the pushing of the first plug-in device into the second plug-in device, can be monitored or controlled, for example by a connected electronic computer unit having a correspondingly running software program.

The electronic computer unit can preferably be designed as a regulating and/or control unit.

The energy charging station can, for example, comprise or be connected to a handling device for orienting and/or positioning the first plug-in device with respect to the second plug-in device. The handling device can preferably be controlled and/or regulated by means of an electronic computer unit with a correspondingly running software program, and comprise at least one robot arm in order to orient and/or position the first plug-in device with respect to the second plug-in device.

The at least one signal transmitting unit and the at least one signal receiving unit can preferably be respectively arranged on an end face of the first and the second plug-in device, which, when a plug-in connection is established, contact each other or are at least arranged opposite one another.

By means of a continuous or constant operative connection in the form of a line-of-sight connection and/or signal connection between the at least one signal transmitting unit and the at least one signal receiving unit, the geometric orientation and/or position of the first plug-in device with respect to the second plug-in device, or vice versa, can be determined sufficiently precisely, for example during the entire plug-in process, which, for example, also leads to increased safety, reliability, and/or fault detection of the plug-in connection.

The completion of the establishing of the plug-in connection can preferably be the achievement of a plugged-together state of the plug-in connection according to predeterminable or defined criteria, preferably geometric-type criteria, such as, for example, a test distance between the first and the second plug-in device that can be measured at a certain point with a tolerance range.

According to a further aspect of the invention, it can be provided that the at least one signal transmitting unit comprises at least one light source, preferably at least one infrared light source, for transmitting the at least one signal.

The at least one light source can preferably be designed as a light-emitting diode (LED) since this has, for example, a compact design and thus a small space requirement. Further, no additional protective glass is necessary, for example.

It is possible that the at least one signal transmitting unit comprises a second light source, preferably a second infrared light source, for transmitting a second signal, wherein the first and the second light source are arranged at a distance from one another in the at least one signal transmitting unit, preferably are arranged at a defined light source distance from one another.

The second light source can also be designed as a light-emitting diode (LED), for example.

During the plug-in process, i.e., the establishing of the plug-in connection, the signal receiving unit, for example a camera, can be moved toward the two light sources, for example. For example, the distance between the first plug-in device and the second plug-in device is hereby reduced, which at the same time leads to the distance between the two light sources being increased in a received and/or detected image, preferably an optical image, of the camera. The distance of the first light source from the second light source, detected in the image and/or determined therefrom, can be used to determine the plug-in depth, i.e., the distance between the first and the second plug-in device. The measurement accuracy here increases, for example, via a visually enlarged distance as the plug-in depth of the first plug-in device into the second plug-in device increases.

According to a further aspect of the invention, it can be provided that the at least one light source has a substantially circular contour in cross section or in one view, or has a punctiform contour in cross section or in one view.

For example, at least one uniform signal can thereby be generated and transmitted for the at least one signal receiving unit.

According to a further aspect of the invention, it can be provided that the at least one light source is split by a diaphragm, in cross section or in one view, into a first and a second light circle or light dot, and preferably the first and the second light circles or light dot are arranged at a distance from one another, preferably arranged at a defined diaphragm distance from one another.

By providing a diaphragm for splitting a light source into preferably two light circles or two light dots, the number of necessary light sources can be reduced, for example, which preferably leads to a reduced probability of error or failure of the arrangement according to the invention.

According to a further aspect of the invention, it can be provided that the second plug-in device preferably comprises a second and a third signal transmitting unit, and preferably the first, second, and third signal transmitting units are arranged at a distance from one another, preferably in order to determine the position of the first plug-in device with respect to the second plug-in device by means of triangulation and/or in order to orient and/or position the first plug-in device with respect to the second plug-in device.

Via the camera, a geometric position of signal-transmitting light sources can be compared, for example, with defined and/or known distances of the light sources from one another, and/or with defined and/or known angles, for example by an electronic computer unit, connected to the camera, with a correspondingly running software program. From this, for example, the orientation and/or position of the second plug-in device can thus be determined, and the first plug-in device can therefore be oriented and/or positioned accordingly to establish the plug-in connection, preferably by means of a connected electronic computer unit with a correspondingly running software program.

According to a further aspect of the invention, it can be provided that the first, second, and third signal transmitting units are arranged on the second plug-in device, preferably on the plug side of the second plug-in device, in such a way that they span a triangular shape, preferably an unequal triangular shape, in cross-section or in one view.

The plug side can preferably be an end face of the second plug-in device. Additionally or alternatively, the plug side can have a substantially planar surface or at least a substantially planar surface section.

The non-uniform orientation or arrangement of signal transmitting units, preferably light sources, can be used, for example, to more precisely ascertain the geometric orientation and/or position of the first plug-in device with respect to the second plug-in device and/or vice versa, since preferably no axes of symmetry are present. For example, this is advantageous given second plug-in devices which are more or less not arranged or cannot be arranged perpendicularly on a vehicle, for example given electrically powered sports cars.

It is possible that the at least one signal comprises at least one light beam, and/or that the at least one signal transmitting unit, preferably the at least one light source, is configured and/or controllable in such a way as to transmit the at least one light beam with different wavelengths and/or with different frequencies, preferably variable pulse frequency and/or pulse duration, preferably to transmit the at least one light beam with different temporal duration.

The wavelength can, for example, be specific, i.e., defined or variable, preferably variable over time, for example during the orientation and/or positioning process of the first plug-in device with respect to the second plug-in device to establish the plug-in connection, and/or during the charging phase of the vehicle.

For example, a first, second, and third light source can be configured such that they transmit a first, second, and third light beam respectively having a different wavelength.

Given the configuration of a signal transmitting unit such that it comprises, for example, an infrared light source with at least three different viewable or transmittable wavelengths, the position of the second plug-in device relative to the first plug-in device can, for example, be determined on the basis of a single infrared light source. An improved search by the first plug-in device with a defined direction control is thus possible, for example.

The frequency can, for example, be specific, i.e., defined, or variable, preferably variable over time, for example variable over time during the charging phase of the vehicle.

A further simplified determination of the orientation and/or positioning of the second plug-in device can thereby be achieved due to the different wavelengths and/or frequencies.

The duration can depend, for example, on the current state of the establishing of the plug-in connection between the first and the second plug-in device. In other words, the at least one light beam can be designed to be variable in terms of wavelength and/or frequency.

An improved identification and/or communication between a signal transmitting unit and a signal receiving unit can thus also be facilitated, for example. Other, i.e., foreign, signal transmitting units can thereby be recognized and thus avoided, for example so that there is no confusion. Further, a differentiation from (foreign) signal transmitting units, preferably light sources, from the surroundings, i.e., the environment, can thereby also be achieved.

Specific wavelengths can, for example, be used to trigger an automated search process for the orientation and/or position of the second plug-in device.

Pulse frequency and/or pulse duration can be reduced during a search operation or plug-in process, for example, in order to avoid a crossfading of the signal receiving unit, i.e., preferably a camera. An improvement in the position accuracy of the first plug-in device with respect to the second plug-in device can thereby preferably be achieved.

According to a further aspect of the invention, it can be provided that the at least one signal receiving unit comprises a camera, preferably an infrared camera, whose light sensitivity is adjustable, preferably as a function of time, and/or as a function of the orientation and/or position with respect to the second plug-in device, and/or as a function of environmental conditions such as, for example, temperature, humidity, air pressure etc.

It is additionally or alternatively possible that the at least one signal transmitting unit comprises at least one light source whose luminous flux is adjustable, preferably adjustable to a set light sensitivity of the camera.

The luminous flux can preferably be adjustable as a function of time, and/or as a function of the orientation and/or position with respect to the first plug-in device, and/or as a function of ambient conditions, such as, for example, temperature, air humidity, air pressure etc., preferably via a connected regulating and/or control unit.

During the plug-in process, i.e., during the establishing of the plug-in connection, the luminous flux of at least one light source can preferably be reduced in order to avoid a crossfading of the camera at close range as the proximity of the first plug-in device to the second plug-in device increases.

It is also possible, for example, that luminous flux is increased during the plug-in process, i.e., during the establishing of the plug-in connection, in order, preferably given bright environmental conditions, to improve the “visibility”, i.e., the reception capability of the light sources, preferably of the infrared light sources.

Additionally or alternatively, given the at least one signal receiving unit, i.e., the camera, the light sensitivity can be increased, for example by adapting the ISO values, during the plug-in process, i.e., during the establishing of the plug-in connection, in order to avoid a crossfading of the camera.

It is also possible, for example, that the light sensitivity in the at least one signal receiving unit, i.e., the camera, is reduced, for example by adapting the ISO values during the plug-in process, i.e., during the establishing of the plug-in connection, in order, preferably given bright environmental conditions, to improve the “visibility”, i.e. the reception capability of the light sources, preferably the infrared light sources.

It is also possible, for example, that luminous flux is reduced during the plug-in process, i.e., during the establishing of the plug-in connection at close range between the first and the second plug-in devices. For example, an end position detection is thereby possible via the size of an illuminated area of a light source, preferably of a light-emitting diode.

According to a further aspect of the invention, it can be provided that the first plug-in device and the second plug-in device comprise plug regions for establishing the plug-in connection, preferably in a plug-in direction, which plug regions are configured to be cylindrical with respect to one another at least in part in order to ensure a selective flexibility upon establishing the plug-in connection and/or after the completion of the establishing of the plug-in connection, preferably during the charging process of the vehicle.

For example, an offset and/or an angular offset can thereby be compensated for during the establishing of the plug-in connection, i.e., during the process of establishing the plug-in connection. This also leads, for example, to a reduction of plug-in forces and/or wear.

On the other hand, the requirements for the accuracy of the orientation and/or positioning of the first plug-in device can be reduced via larger tolerance ranges for offset and/or angular offset.

In addition, it is possible that, even after the first plug-in device is locked with the second plug-in device (state of the established plug-in connection), a resilience and, for example, a mechanical decoupling of the first plug-in device from the energy charging station, or a mechanical decoupling of the handling device from the first plug-in device with respect to the energy-charging station, is provided in order, for example, to be able to again decouple or disconnect the first plug-in device from the second plug-in device after a vehicle charging process has been completed. Damage due to forces acting on the first and/or the second plug-in device are thereby also prevented, for example.

A second general aspect of the invention relates to a method for establishing, preferably automatically, a preferably releasable and/or positive-fit plug-in connection between an energy charging station and a vehicle in order to transmit energy, preferably electrical energy, into an energy storage device of the vehicle, preferably with an arrangement as disclosed herein, wherein a first plug-in device is connected to the energy charging station; a second plug-in device is connected to the vehicle; and the second plug-in device comprises at least one signal transmitting unit and the first plug-in device comprises at least one signal receiving unit for receiving at least one (transmitted) signal of the at least one signal transmitting unit. The method according to the invention is characterized in that the at least one signal receiving unit and the at least one signal transmitting unit are arranged on the first and on the second plug-in device and are configured with respect to one another, preferably communicatively, in such a way that the at least one received signal for orienting and/or positioning the first plug-in device is processed with respect to the second plug-in device and preferably evaluated; and in that, at least for the establishing, preferably at least during the establishing process, of the plug-in connection between the first and the second plug-in device, a, preferably interruption-free or obstacle-free, line-of-sight connection and/or a, preferably interruption-free or obstacle-free, signal connection is formed between the at least one signal receiving unit and the at least one signal transmitting unit, preferably at least until the establishing of the plug-in connection is completed and/or beyond, for example at least until the process of transmitting energy into the energy storage device of the vehicle is completed.

Furthermore, according to a further aspect of the invention it can be provided that a wireless communication is established between a transmitter/receiver unit of the vehicle and a transmitter/receiver unit of the charging station, and/or a request for charging, preferably conductive charging, of the energy storage device of the vehicle is made by the vehicle via the transmitter/receiver unit of the vehicle to the transmitter/receiver unit of the charging station; and/or the posed request is confirmed and a charging point is assigned by the energy charging station; and/or the first plug-in device is provided at the energy charging station and the second plug-in device is provided on the vehicle at the charging point of the energy charging station, preferably with controllable robot arms and robot joints which can perform translational and/or rotational movements.

It is possible that the at least one signal transmitting unit is activated and at least one signal is transmitted, wherein preferably the pulse duration and frequency of at least one signal transmitting unit or of the at least one signal can be predetermined by the energy charging station and is specific to the current charging process; and/or the at least one transmitted signal is received by the at least one signal receiving device and preferably, as soon as a pulse duration and frequency are provided by the energy charging station, a comparison of the target/actual specification serves as a further possibility for identifying the vehicle, and/or a position of the second plug-in device is determined by processing and/or evaluating the at least one received signal, preferably by an electronic computer unit at the charging station; and/or the first plug-in device is oriented and/or positioned with respect to the determined position of the second plug-in device until a defined position of the first plug-in device with respect to the second plug-in device is achieved, preferably by an electronic computer unit at the loading station; and/or the plug-in connection is established between the first and the second plug-in connection by inserting the first plug-in device into the second plug-in device, wherein, at least for establishing the plug-in connection between the first and the second plug-in device, a preferably interruption-free or obstacle-free line-of-sight connection and/or a preferably interruption-free or obstacle-free signal connection is established between the at least one signal receiving unit and the at least one signal transmitting unit, preferably until completion of the plug-in connection and/or beyond, for example at least until the completion of the process for transmitting energy into the energy storage device of the vehicle.

The completion of the plug-in connection can be, for example, a defined or predetermined end state of the first plug-in device plugged into the second plug-in device.

To avoid repetition, features directed purely toward the device of the arrangement according to the invention and/or disclosed in conjunction therewith should also be considered to be disclosed and be able to be claimed in accordance with the method and vice versa.

Identical or functionally equivalent components or elements are denoted by the same reference signs in Figures. For the explanation thereof, reference is also made in part to the description of other exemplary embodiments and/or Figures in order to avoid repetitions.

The following detailed description of the exemplary embodiments illustrated in Figures serves for more detailed illustration or clarification and is not intended to limit the scope of the invention in any way.

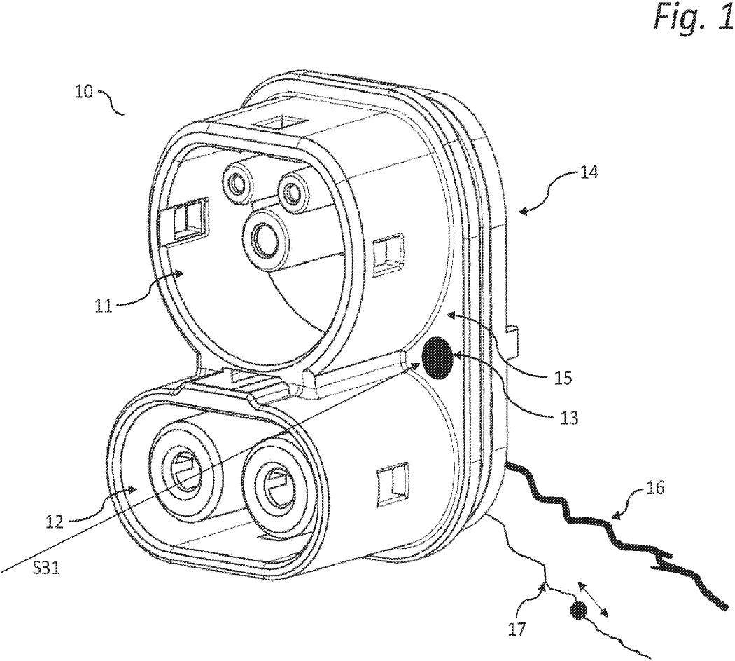

FIG. 1 shows a perspective view of an exemplary embodiment of the first plug-in device (10).

The first plug-in device (10), also referred to as a plug-in connector (10), charging plug (10), or connector (10), comprises a housing (14) made of an insulation material, for example an insulating plastic, and has a first plug region (11), i.e. a first plug face (11), and a second plug region (12), i.e. a second plug face (12), for forming a plug-in connection.

In both the first plug region (11) and in the second plug region (12), electrical conductors and/or contacts are located in cylindrical housing wall portions, which are preferably arranged symmetrically and serve for transmitting electrical energy, i.e., electrical current.

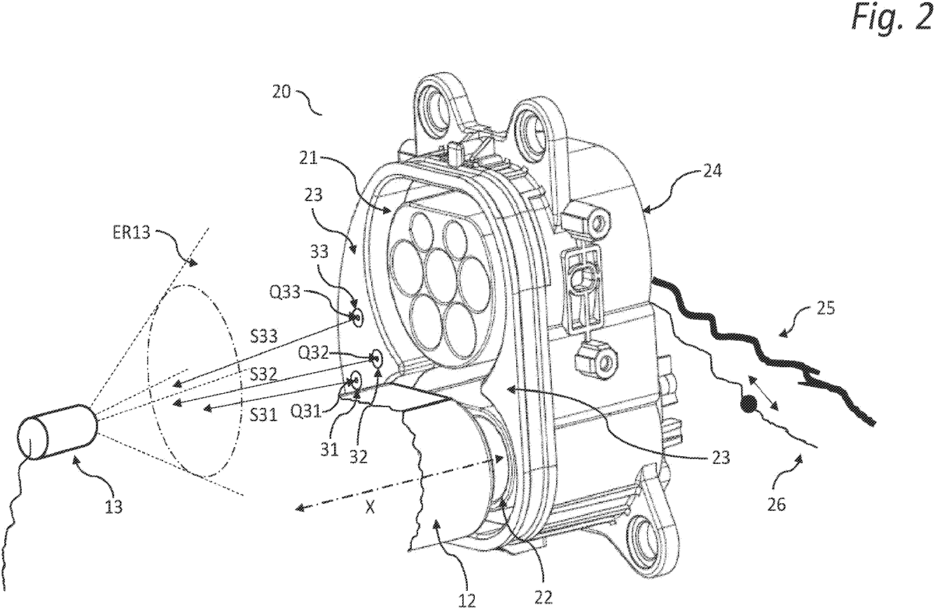

The first plug region (11) and the second plug region (12), as well as the cylindrical housing wall portions with the integrated electrical conductors and/or contacts, are embodied or designed in such a way that they can be inserted or plugged into a corresponding second plug-in device (20) (see FIG. 2 in this regard) to establish a plug-in connection, and preferably form a releasable positive-fit connection.

The first plug-in device (10) is preferably connected via at least one cable (16) for energy transmission, and preferably via at least one cable (17) for signal and/or data transmission, to an energy charging station, preferably to an electronic computer unit of the energy charging station.

The electronic computer unit can be designed as a control and/or regulating unit, for example.

On the end face or plug side, i.e. the side of the first plug-in device (10) to be plugged in, which is associated with the first and the second plug region (11, 12) of the second plug-in device (20) corresponding thereto, a signal receiving unit (13) is arranged on the end face (15) of the first plug-in device (10), i.e., in the housing (14) with respect to the end face (15).

The signal receiving unit (13) is designed as or comprises a camera (13), preferably as an infrared camera (13). The camera (13) is hereby oriented and/or positioned in such a way that it “looks” in the direction of an established plug-in connection with a second plug-in device (20). In other words, the camera (13) is positioned at or in the housing (14) of the plug-in device (10) so as to be exposed in order to be able to acquire or receive signals, for example light beams, of signal transmitting units (31, 32, 33) (see FIG. 2 in this regard) of a second plug-in device (20) without interruption.

The signal receiving device (13), i.e., the camera (13), is preferably arranged at a distance in proximity to the first and second plug regions (11, 12), and at a distance from an edge region of the housing (14). A compact size of the first plug-in device (10) is thus achieved, for example.

The camera (13) is preferably connected to the at least one cable (17) for signal and/or data transmission, preferably also for supplying energy to the camera (13), so that signals (S31) received and optionally converted by the camera (13) can be forwarded for processing and/or evaluation, preferably to an electronic computer unit which is designed as a regulating and/or control unit.

FIG. 2 shows a perspective view of an exemplary embodiment of the second plug-in device (20), in particular together with a schematically illustrated signal receiving unit (13) of the first plug-in device (10) (see also FIG. 1 in this regard).

The second plug-in device (20), also referred to as a charging socket (20) or inlet (20), comprises a housing (24) made of an insulation material, for example an insulating plastic, and has a first plug region (21), i.e., a first plug-in face (21), and a second plug region (22), i.e., a second plug-in face (22), for forming a plug-in connection.

Electrical conductors and/or contacts in cylindrical housing wall portions, which are preferably arranged symmetrically and serve for transmitting electrical energy, i.e., electrical current, are located both in the first plug region (21) and in the second plug region (22).

The first plug region (21) and the second plug region (22), as well as the cylindrical housing wall portions with the integrated electrical conductors and/or contacts, are embodied or designed in such a way that they can be inserted or plugged into the corresponding first plug-in device (10) (see FIG. 1 in this regard) for establishing a plug-in connection, and preferably form a releasable positive-fit connection.

From a synopsis of FIGS. 1 and 2, it can be seen, for example, that the two plug regions (11, 12) of the first plug-in device (10) and the two plug regions (21, 22) of the second plug-in device (20) are designed such that they can be plugged into one another, preferably in a translational movement in the plug-in direction (X), to establish a plug-in connection.

For further illustration in this respect, FIG. 2 shows a portion of the second plug region (12) of the first plug-in device (10) at the corresponding opposite or associated plug region (22) of the second plug-In device (20).

The second plug-in device (20) is fastened to a vehicle, preferably an electric vehicle, so as to be releasable.

The second plug-in device (20) is further preferably connected to an energy storage of the vehicle via at least one cable (25) for energy transmission, and preferably to the vehicle, preferably to an electronic computer unit of the vehicle, via at least one cable (26) for signal and/or data transmission.

The electronic computer unit can be designed as a control and/or regulating unit, for example.

On the end face or the plug side, i.e., on the side of the second plug-in device (20) that is to be plugged in, which is associated with the first and the second plug region (21, 22) of the first plug-in device (10) corresponding thereto, three signal transmitting units (31, 32, 33) for transmitting respectively at least one signal (S31, S32, S33) are arranged on the end face (23) of the second plug-in device (20), i.e., in the housing (24) with respect to the end face (23).

The three signal transmitting units (31, 32, 33) preferably respectively comprise a light-emitting diode (LED) as a light source (Q31, Q32, Q33). Preferably, the first, second, and third light-emitting diodes (Q31, Q32, Q33) are configured or controlled in such a way that they can transmit at least one signal in the form of an infrared light beam.

In a further exemplary embodiment of the invention, it can also be provided, for example, that the light sources (Q31, Q32, Q33) are not arranged flush on the end face (23) or with the end face (23) but rather are arranged inwardly, i.e., offset into the housing (24), and guide the at least one signal, preferably in the form of an infrared light beam, to the respective light output position at the end face (23) by means of an optical waveguide.

Further, the first, second, and third light-emitting diodes (Q31, Q32, Q33) can be configured or activated in such a way that they transmit infrared light beams with respective different wavelengths and/or different frequencies, preferably as a function of time or as a function of ambient conditions

The three light-emitting diodes (Q31, Q32, Q33) can preferably be activated via the at least one cable (26) for signal and/or data transmission and/or can be supplied with electrical energy.

Further, in relation to the camera (13), by way of example in FIG. 2, the detection space (ER13) of the camera (13) is represented by transmitted signals, that is to say light beams (S31, S32, S33) of the three light-emitting diodes (Q31, Q32, Q33).

Preferably, the three signal transmitting units (31, 32, 33) with the light-emitting diodes (Q31, Q32, Q33) are arranged spaced apart in proximity to the first and second plug regions (21, 22) and are arranged at a distance from an edge region of the housing (24). A compact size of the second plug-in device (20) thus is achieved, for example.

Due to the exposed position of the three signal transmitting units (31, 32, 33), and thus of the three light-emitting diodes (Q31, Q32, Q33), the camera (13) is hereby in continuous, i.e., uninterrupted or obstacle-free, line-of-sight connection and/or signal connection with the light-emitting diodes (Q31, Q32, Q33).

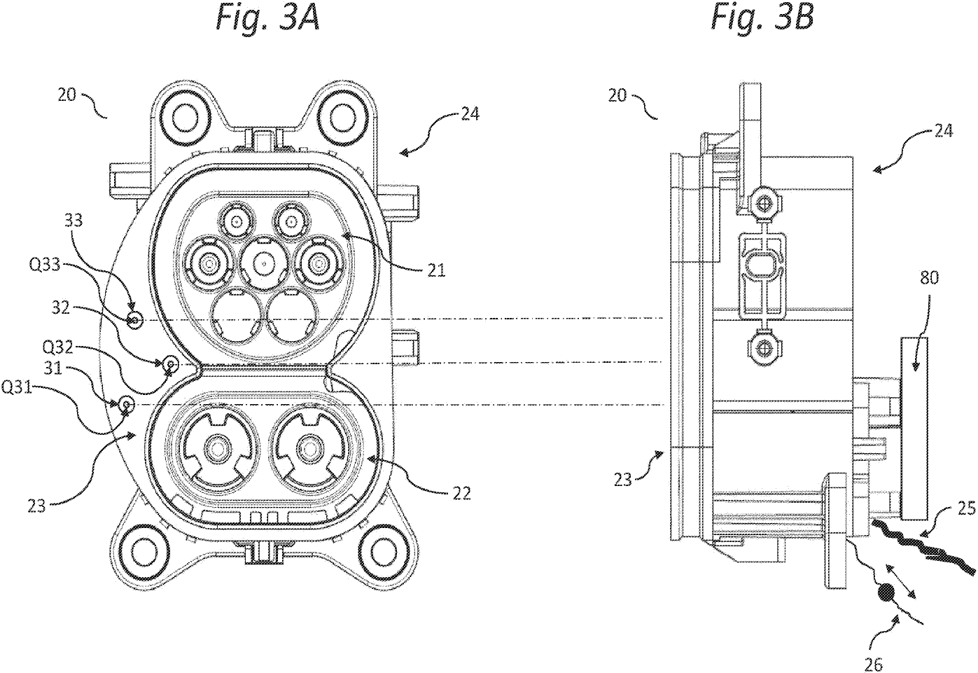

For clarification, FIG. 3A shows a front view of the second plug-in device (20) shown in FIG. 2, and FIG. 3B shows a side view of the second plug-in device (20) shown in FIG. 2.

In order to avoid repetition, a description of components and/or elements that have already been shown is omitted below.

As can clearly be seen from FIG. 3A, in this view the three light-emitting diodes (Q31, Q32, Q33) are arranged in the housing (24) of the second plug-in device (20) at a distance from one another, or are arranged on the end face (23) of the second plug-in connection (20) at a distance from one another, in such a way that they span a scalene triangle, i.e., a triangle shape having three different side lengths.

The three light-emitting diodes (Q31, Q32, Q33) are arranged on that side of the second plug-in device (20) which, in the state of the plug-in connection, is situated opposite to or contacts that side of the first plug-in device (10) with the camera (13). A continuous line-of-sight connection between the components of the camera (13) communicating with one another, i.e. in line-of-sight and/or signal connection, and the three light-emitting diodes (Q31, Q32, Q33) can thereby be ensured.

It can also be learned, from the side view in FIG. 3B, that the second plug-in device (20) has, on the side opposite the first and second plug regions (21, 22), a coupling structure (80) for a detachable coupling to a vehicle, preferably an electric vehicle.

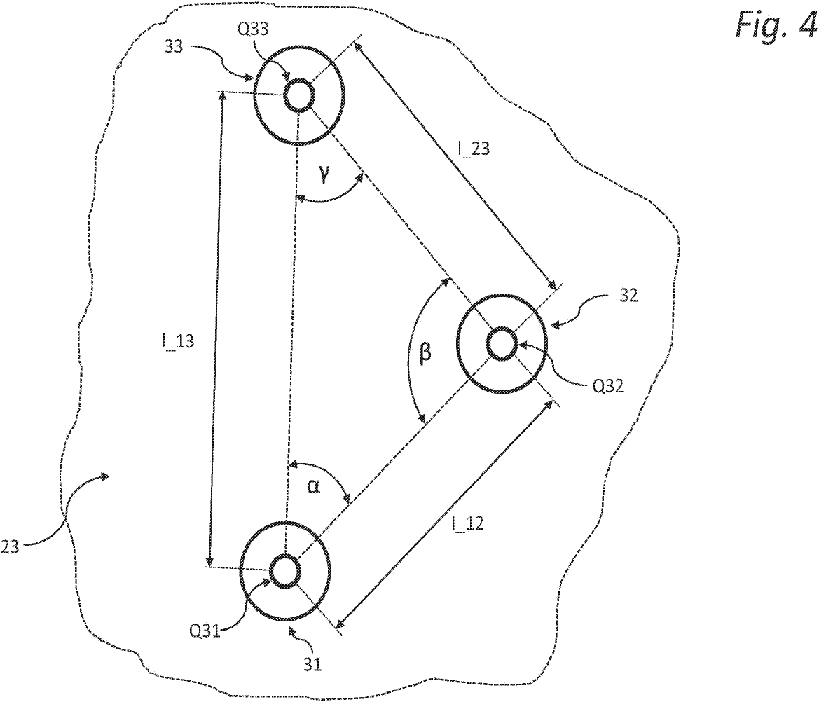

FIG. 4 shows an enlarged view of a partial region of the second plug-in device (20) shown in FIG. 2, with the first signal transmitting unit (31), second signal transmitting unit (32), and third signal transmitting unit (33).

The first, second, and third signal transmitting units (31, 32, 33) comprise a respective light-emitting diode (Q31, Q32, Q33) which, as described above, are respectively arranged at a distance from one another and span a scalene triangle.

The illustrated angles α, β, and γ between the sides indicated in the alternative, which connect the individual light-emitting diodes (Q31, Q32, Q33), are hereby different and known, i.e., defined. The first light-emitting diode (Q31) is arranged at a distance from the second light-emitting diode (Q32) over the first distance (l_12). The second light-emitting diode (Q32) is arranged at a distance from the third light-emitting diode (Q33) over the second distance (l_23), and the third light-emitting diode (Q33) is arranged at a distance from the first light-emitting diode (31) over the third distance (l_13).

With knowledge of the length of the first distance (l_12), the second distance (l_23), and the third distance (l_13), as well as of the angles α, β, and γ, the orientation and/or position of the second plug-in device (20), together with the received light beams (S31, S32, S33) (see FIG. 2 in this regard), can be determined by the camera (13) by means of triangulation, i.e., by means of angle measurements.

With the aid of the camera (13), the beam direction of a light beam (S31) or of a plurality of light beams (S31, S32, S33) can be determined continuously, for example, preferably using a control and/or regulating unit, and/or the distance between the camera (13) and the light-emitting diodes (Q31, Q32, Q33) and thus the orientation and/or the position of the first plug-in device (10) with respect to the second plug-in device (20).

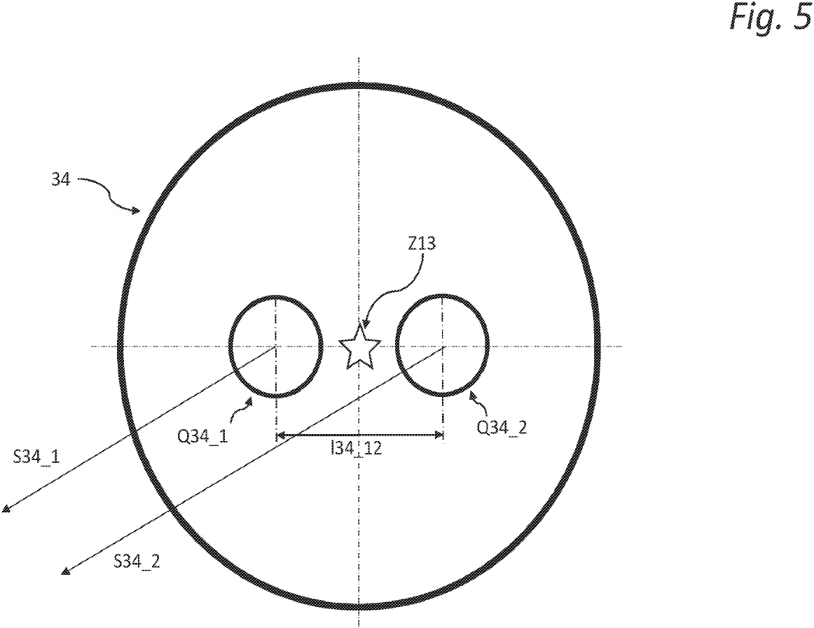

FIG. 5 shows an exemplary embodiment of a signal transmitting unit (34) with a first light source, preferably a first light-emitting diode (Q34_1), and a second light source, preferably a second light-emitting diode (Q34_1), wherein the first light-emitting diode (Q34_1) is arranged at a distance from the second light-emitting diode (Q34_1) over the light source distance I34_12.

The first and second light-emitting diodes (Q34_1, Q34_2) are preferably configured such that they can transmit at least one signal in the form of an infrared light beam (S34_1, S34_2).

Here, too, the orientation and/or position of the second plug-in device (20) can be determined by means of triangulation between the camera (13) and the signal transmitting unit (34). In this instance, it is particularly advantageous since only one signal transmitting unit (34) must be attached to the second plug-in device (20), i.e., be integrated in the housing (24) of the second plug-in unit (20).

In addition, in FIG. 5 the center of the recording region of the camera (13) and its position is represented with the star symbol (Z13), said center being set during the process of establishing the plug-in connection.

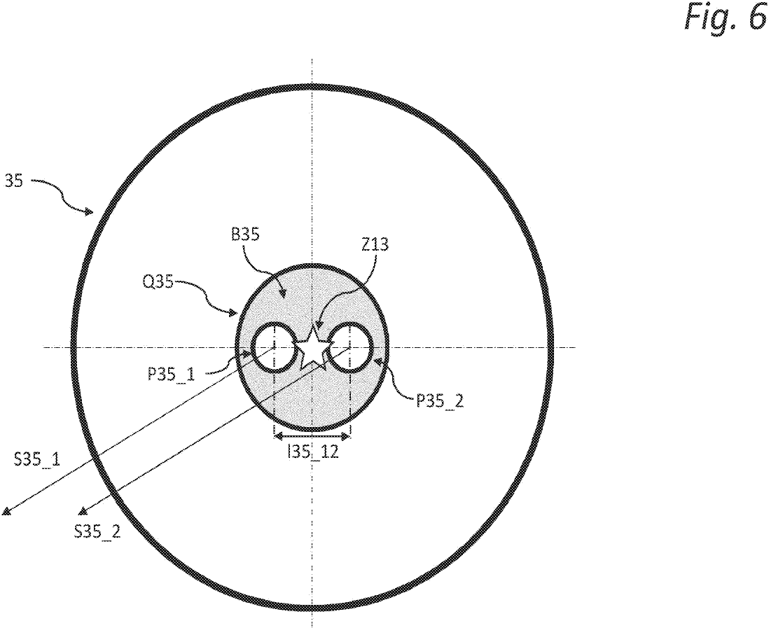

FIG. 6 shows a further exemplary embodiment of a signal transmitting unit (35), with a single light source (Q35) and a diaphragm (B35) preferably positioned in the beam direction, said diaphragm having two substantially circular holes or openings for splitting the light source (Q35) into two light circles or light dots (P35_1, P35_2) at a distance from one another over a diaphragm distance (I35_12).

The light source (Q35) is preferably designed as a light-emitting diode (Q35) which is configured to transmit light beams (S35_1, S35_2) in the infrared range, preferably of different wavelengths and/or different frequencies.

Further, the light-emitting diode (Q35) can be configured or activated differently as a function of ambient conditions and/or as a function of time, for example during a charging operation of the vehicle.

The orientation and/or position of the second plug-in unit (20) and/or of the first plug-in unit (10) can also be determined with such a signal transmitting unit (35) and a camera (13), by means of triangulation, in order to then bring the first plug-in unit (10) into a corresponding orientation and/or position in which the establishing of a plug-in connection is possible.

In addition, also depicted in FIG. 6 with the star symbol (Z13) is the center of the recording area of the camera (13) and its position, which is set during the process of establishing the plug-in connection.

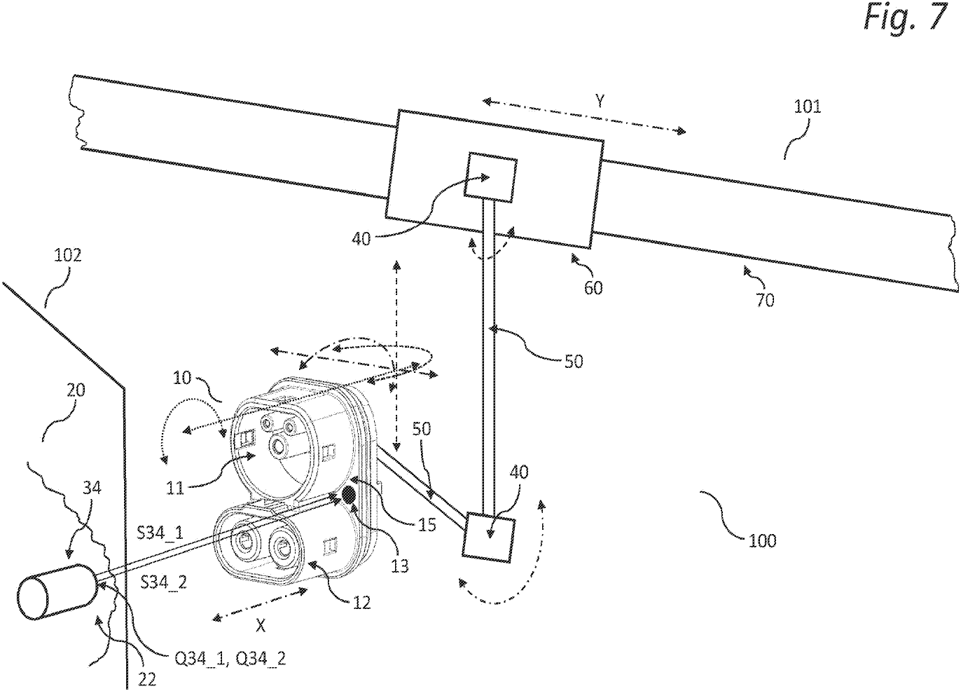

FIG. 7 shows an exemplary embodiment of the arrangement according to the invention (100), with the first and the second plug-in device (10, 20) for establishing a plug-in connection between the first and the second plug-in device (10, 20) to transmit energy, preferably electrical energy, from an energy charging station (101) into an energy store of a vehicle (102).

The vehicle (102) with the second plug-in device (20) detachably fastened thereto, and further components and elements, are shown schematically in FIG. 7.

For clarity, additional components and/or elements (for example cables, energy storages, electronic computer units, transmitting/receiving units, regulating and/or control units, communication devices etc.), preferably of the vehicle (102) and of the charging station (101), are not also shown in FIG. 7.

The second plug-in device (20) comprises a signal transmitting unit (34) which is preferably formed with two light-emitting diodes (Q34_1, Q34_2). The two light-emitting diodes (Q34_1, Q34_2) are arranged side by side, spaced apart from one another in the signal transmitting unit (34) over a defined light source distance (I34_12) (not visible in FIG. 7), and therefore transmit two signals which are spaced apart from one another, in the form of light beams (S34_1, S34_2), in the direction of the camera (13), i.e., into the detection space of the camera (13) at the first plug-in device (10).

The first plug-in device (10) with the camera (13) can be translationally and/or rotationally moved via a system of robot arms (50) and robot arm joints (40) (see in this regard the dashed lines with arrows to clarify the degrees of freedom of movement of the first plug-in device (10) via the system of robot arms (50) and robot arm joints (40)).

A robot arm (50) is in turn connected via a robot arm joint (40) to a carriage (60), which is executed so as to be translationally movable along a rail (70) of a charging point of the charging station (101) (see in this regard the direction of movement Y).

Accordingly, the first plug-in device (10) can assume a plurality of orientations and/or positions.

The camera (13) receives the transmitted light beams (S34_1, S34_2), which can have different wavelengths and/or different frequencies, for example. It is possible that the wavelengths and/or the frequencies are variable over time and, for example, depend on ambient conditions and/or preferably the state of the energy storage device of the vehicle (102).

Via a regulating and/or control unit of the charging station (101) which, for example, is connected to the camera (13), it is possible to determine the orientation and/or the positioning of the second plug-in device (20) with respect to the first plug-in device (10) or vice versa by means of triangulation on the basis of the received light beams (S34_1, S34_2) and the defined light source distance (I34_12) of the two light-emitting diodes (Q34_1, Q34_2), and then to adjust the first plug-in device (10) according to the orientation and/or positioning of the second plug-in device (20) and subsequently move it in the direction of the plug-in device (20).

The camera (13) is thereby in constant “visual contact”, i.e., in line-of-sight connection and in signal connection, with the two light-emitting diodes (Q34_1, Q34_2), preferably until the establishing of the plug-in connection between the first plug-in device (10) and the second plug-in device (20) is completed and/or beyond, for example at least until the charging process of the energy storage device of the vehicle is complete.

As already shown above, the invention can provide an arrangement, i.e., a plug-in connection system, for conductively charging an electric vehicle, which system is improved with regard to establishing the plug-in connection between the electric vehicle and the charging station.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 First plug-in device
11 First plug region of the first plug-in device
12 Second plug region of the second plug-in device
13 Signal receiving unit, camera
14 Housing of the first plug-in device
15 End face of the first plug-in device
16 Cable for energy transmission
17 Cable for signal and/or data transmission
20 Second plug-in device
21 First plug region of the second plug-in device
22 Second plug region of the second plug-in device
23 End face of the second plug-in device
24 Housing of the second plug-in device
25 Cable for energy transmission
26 Cable for signal and/or data transmission
31 First signal transmitting unit
32 Second signal transmitting unit
33 Third signal transmitting unit
34 Signal transmitting unit with two light sources
35 Signal transmitting unit with a light source and a diaphragm
40 Robot arm joint
50 Robot arm
60 Carriage
70 Rail
80 Coupling structure of the second plug-in device
α Angle
β Angle
γ Angle
B35 Diaphragm
1_12 First distance
1_23 Second distance
1_13 Third distance
I34_12 Light source distance
I35_12 Diaphragm distance
P35_1 Light circle, light dot
P35_2 Light circle, light dot
Q31 First light source/light-emitting diode
Q32 Second light source/light-emitting diode
Q33 Third light wave/light-emitting diode
Q34_1 First light source/light-emitting diode
Q34_2 Second light source/light-emitting diode
Q35 Light source/light-emitting diode
S31 Light beam/infrared light beam
S32 Light beam/infrared light beam
S33 Light beam/infrared light beam
S34_1 Light beam/infrared light beam
S34_2 Light beam/infrared light beam
S35_1 Light beam/infrared light beam
S35_2 Light beam/infrared light beam
X Plug-in direction
Y Direction of movement of the carriage
Z13 Center of the recording area of the signal receiving unit/camera

1. An arrangement for establishing a plug-in connection between an energy charging station and a vehicle in order to transmit energy into an energy storage device of the vehicle, comprising:
a first plug-in device which is connectable or connected to the energy charging station; and
a second plug-in device which is connectable or connected to the vehicle,
the second plug-in device comprising at least one signal transmitting unit,
wherein the first plug-in device comprises at least one signal receiving unit configured to receive at least one signal of the at least one signal transmitting unit, wherein
the at least one signal receiving unit and the at least one signal transmitting unit are arranged on the first and the second plug-in device and configured with respect to one another such that the at least one received signal is provided for orienting and/or positioning the first plug-in device with respect to the second plug-in device, and
wherein, at least for establishing the plug-in connection between the first and the second plug-in device, a line-of-sight connection and/or a signal connection is formed between the at least one signal receiving unit and the at least one signal transmitting unit.

2. The arrangement of claim 1, wherein the at least one signal transmitting unit comprises at least one light source configured to transmit the at least one signal.

3. The arrangement of claim 2,
wherein the at least one signal transmitting unit comprises a second light source configured to transmit a second signal, and
wherein the first and the second light sources are arranged at a distance from one another in the at least one signal transmitting unit.

4. The arrangement of claim 2,
wherein the at least one light source has a circular contour in cross section or a punctiform contour in cross section.

5. The arrangement of claim 2,
wherein the at least one light source is divided by a diaphragm in cross section into a first and a second light circle or light point.

6. The arrangement of claim 1,
wherein the second plug-in device comprises a second and a third signal transmitting unit.

7. The arrangement of claim 6,
wherein the first, second, and third signal transmitting units are arranged on the second plug-in device.

8. The arrangement of claim 1,
wherein the at least one signal comprises at least one light beam, and/or the at least one signal transmitting unit is configured and/or is activatable so as to transmit the at least one light beam with different wavelength and/or with different frequency.

9. The arrangement of claim 1,
wherein the at least one signal receiving unit comprises a camera whose light sensitivity is adjustable, and/or the at least one signal transmitting unit comprises at least one light source whose luminous flux is adjustable.

10. The arrangement of claim 1,
wherein the first and the second plug-in device comprise plug regions configured to establish the plug-in connection, which plug regions are configured so as to be at least partially cylindrical with respect to one another to ensure a selective resilience in the-establishing the plug-in connection and/or after completion of establishing the plug-in connection.

11. A method for establishing a plug-in connection between an energy charging station and a vehicle in order to transmit energy into an energy storage device of the vehicle with the arrangement of claim 1, comprising:
connecting a first plug-in device to the energy charging station; and
connecting a second plug-in device to the vehicle,
the second plug-in device comprising at least one signal transmitting unit,
wherein the first plug-in device comprises at least one signal receiving unit configured to receive at least one signal of the at least one signal transmitting unit, wherein
the at least one signal receiving unit and the at least one signal transmitting unit are arranged on the first and the second plug-in device and configured with respect to one another such that the at least one received signal is processed for orienting and/or positioning the first plug-in device with respect to the second plug-in device, and
wherein, at least for establishing the plug-in connection between the first and the second plug-in device, a line-of-sight connection and/or a signal connection is formed between the at least one signal receiving unit and the at least one signal transmitting unit.

12. The method of claim 11, wherein
a wireless communication is established between a transmitting/receiving unit of the vehicle and a transmitting/receiving unit of the charging station, and/or
wherein a request by the vehicle for charging of the energy storage device of the vehicle is made via the transmitting/receiving unit of the vehicle to the transmitting/receiving unit of the charging station; and/or
wherein the request is confirmed and a charging point is assigned by the energy charging station; and/or
wherein the first plug-in device is provided at the energy charging station, nd the second plug-in device is provided on the vehicle at the charging point of the energy charging station.

13. The method claim 11, wherein
the at least one signal transmitting unit is activated and at least one signal is transmitted, and/or
wherein the at least one transmitted signal is received by the at least one signal receiving device and/or
wherein a position of the second plug-in device is determined by processing the at least one received signal, and/or
wherein the first plug-in device is oriented and/or positioned with respect to the determined position of the second plug-in device until a defined position of the first plug-in device with respect to the second plug-in device is achieved, and/or
wherein the plug-in connection between the first and the second plug-in device is established by plugging the first plug-in device into the second plug-in device, wherein a line-of-sight connection and/or a signal connection is formed between the at least one signal receiving unit and the at least one signal-transmission unit, at least to establish the plug-in connection between the first and the second plug-in device.

14. The arrangement of claim 1, wherein the energy comprises electrical energy.

15. The arrangement of claim 1, wherein, at least for establishing the plug-in connection between the first and the second plug-in device, the line-of-sight connection and/or the signal connection is formed between the at least one signal receiving unit and the at least one signal transmitting unit until the establishing of the plug-in connection is complete.

16. The arrangement of claim 2, wherein the at least one light source comprises at least one infrared light source.

17. The arrangement of claim 3, wherein the second light source comprises a second infrared light source, and
wherein the distance comprises a defined light source distance.

18. The arrangement of claim 5, wherein the first and the second light circle or light dot are arranged at a distance from one another.

19. The arrangement of claim 18, wherein the distance comprises a defined diaphragm distance.

20. The arrangement of claim 6, wherein the first, second, and third signal transmitting units are arranged at a distance from one another in order to determine a position of the first plug-in device with respect to the second plug-in device by triangulation and/or in order to orient and/or position the first plug-in device with respect to the second plug-in device.
